(19) United States
(12) Patent Application Publication
(10) Pub. No.: US 2019/0136154 A1
(43) Pub. Date: May 9, 2019

(54) PROCESS FOR MAKING A FABRIC SOFTENER COMPOSITION BY DILUTING A CONCENTRATED FABRIC SOFTENER PREMIX

(71) Applicant: The Procter & Gamble Company, Cincinnatti, OH (US)

(72) Inventors: Pieter Jan Maria SAVEYN, Heusden (BE); Vincenzo GUIDA, Brussels (BE); Susana FERNANDEZ-PRIETO, Brussels (BE); Evelyne Johanna Lutgarde VAN HECKE, Bachte-Maria-Laarne (BE); Dries VAES, Houtvenne (BE); Bruno Jean-Pierre MATTHYS, Brussels (BE)

(21) Appl. No.: 16/181,382

(22) Filed: Nov. 6, 2018

(30) Foreign Application Priority Data
Nov. 7, 2017 (EP) 17200259.4

(51) Int. Cl. C11D 3/30; C11D 3/50; C11D 3/37; C11D 11/00

(52) U.S. Cl. CPC C11D 3/30; C11D 11/0017; C11D 3/3707; C11D 3/50

(57) ABSTRACT

A process to make a liquid fabric softener composition by diluting a concentrated fabric softener premix including quaternary ammonium ester fabric softening active and microfibrous cellulose, which may result in fabric softener compositions with rich appearance at reduced manufacturing complexity.

### FIELD OF THE INVENTION

The invention is directed to a process of making a fabric softener composition.

### BACKGROUND OF THE INVENTION

Fabric softener compositions provide benefits to treated fabrics, particularly in the last rinse phase of the laundry process, after the addition of the detergent composition. Such benefits include fabric softening, provided by the incorporation of fabric softener actives. Fabric softener compositions are made in one or more manufacturing locations before being transported to local distribution warehouses from where they are further distributed to retailers. Because typical fabric softener compositions contain a large fraction of water, it is desired for environmental and logistic reasons to make a concentrated premix in the manufacturing location; transport this premix to the local manufacturing sites where the concentrated premix is diluted and finished to make a final fabric softener composition, before distributing the final fabric softener composition to the retailers.

To provide a rich appearance to the fabric softener composition, to improve the dosing experience, and to avoid splashing upon dosing, thickeners are added to thicken the fabric softener composition. However, upon dilution of a concentrated fabric softener premix with water, the viscosity decreases and the rich appearance is reduced. To overcome this issue, additional thickener can be added to the final fabric softener composition after the dilution step. However, this solution complicates the supply chain process and increases manufacturing costs as the local distribution warehouses need to be equipped with additional storage tanks, dosing and mixing units to disperse extra thickener after diluting the fabric softener premix.

Hence, there is still a need for a process to make a fabric softener composition with a rich appearance through the dilution of a concentrated fabric composition premix at reduced manufacturing complexity.

WO 2011/119796 (A1) discloses a process of making a diluted fabric softening composition from a concentrated fabric softener hydrate. WO2008/079693 (A1) relates to a cationic surfactant composition comprising microfibrous cellulose to suspend particulates.

### SUMMARY OF THE INVENTION

The present disclosure relates to a process to make a liquid fabric softener composition by diluting a concentrated fabric softener premix comprising quaternary ammonium ester fabric softening active and microfibrous cellulose. The process to make the fabric softener of the present invention results in fabric softener compositions with rich appearance at reduced manufacturing complexity.

### BRIEF DESCRIPTION OF THE DRAWINGS

The figures herein are illustrative in nature and are not intended to be limiting.

FIG. 1 shows an apparatus (Apparatus A) useful for mixing processes.

FIG. 2 shows a detail of the apparatus of FIG. 1.

FIG. 3 show a circulation loop system (Apparatus B).

### DETAILED DESCRIPTION OF THE INVENTION

### Definitions

As used herein, the articles including “a” and “an” when used in a claim, are understood to mean one or more of what is claimed or described.

As used herein, the term “consumer acceptable” or “acceptable to consumers” refers to compositions that appear visually, preferably to the unaided eye, to lack visible cracks, distortions, or unevenness, that would cause the consumer to have concerns regarding the quality of the product contained in the packaging or the ability of the packaging to withstand shipping or storage conditions.

As used herein, the terms “include”, “includes” and “including” are meant to be non-limiting.

Unless otherwise noted, all component or composition levels are in reference to the active portion of that component or composition, and are exclusive of impurities, for example, residual solvents or by-products, which may be present in commercially available sources of such components or compositions. For example, it is known that quaternary ammonium esters typically contain the following impurities: the monoester form of the quaternary ammonium ester, residual non-reacted fatty acid, and non-quaternized esteramines.

All percentages and ratios are calculated by weight unless otherwise indicated. All percentages and ratios are calculated based on the total composition unless otherwise indicated.

All ratios are calculated as a weight/weight level of the active material, unless otherwise specified. All measurements are performed at 25° C. unless otherwise specified.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

### The Concentrated Fabric Softener Premix

As used herein, “concentrated fabric softener premix” refers to any intermediate composition suitable to be diluted to the liquid fabric softener composition of the present invention, capable of softening fabrics, e.g., clothing in a domestic washing machine.

Aqueous concentrated fabric softener premixes are preferred. For such aqueous concentrated fabric softener premix, the water content may be present at a level of from 5% to 92%, preferably from 50% to 92%, more preferably from 64% to 90% by weight of the liquid fabric softener composition.

The pH of the neat concentrated fabric softener premix is typically acidic to improve hydrolytic stability of the quaternary ammonium ester softening active and may be from pH 2 to 6, preferably from pH 2 to 4.5, more preferably from 2 to 3.5 (see Methods).

To provide a flowable concentrated fabric softener premix whilst obtaining liquid fabric softener composition with a rich appearance after dilution of said premix, the viscosity of the concentrated fabric softener premix may be from 50 mPa·s to 10000 mPa·s, preferably from 150 mPa·s to 8000 mPa·s, more preferably from 200 mPa·s to 5000 mPa·s, even more preferably from 500 mPa·s to 4000 mPa·s, most preferably from 800 mPa·s to 3000 mPa·s as measured at 21° C. with a Brookfield® DV-E viscosimeter at 60 rpm (see Methods).

### The Liquid Fabric Softener Composition

As used herein, “liquid fabric softener composition” refers to any treatment composition comprising a liquid capable of softening fabrics, e.g., clothing in a domestic washing machine. The composition can include solids or gases in suitably subdivided form, but the overall composition excludes product forms which are non-liquid overall, such as tablets or granules. The liquid fabric softener composition preferably has a density from 0.9 to 1.3 g·cm⁻³.

Aqueous liquid fabric softening compositions are preferred. For such aqueous liquid fabric softener compositions, the water content can be present at a level of from 5% to 97%, preferably from 50% to 96%, more preferably from 70% to 95% by weight of the liquid fabric softener composition.

The pH of the neat liquid fabric softener composition is typically acidic to improve hydrolytic stability of the quaternary ammonium ester softening active and may be from pH 2 to 6, preferably from pH 2 to 4.5, more preferably from 2 to 3.5 (see Methods).

To provide a rich appearance while maintaining pourability of the liquid fabric softener composition, the viscosity of the liquid fabric softener composition may be from 50 mPa·s to 1000 mPa·s, preferably from 60 mPa·s to 700 mPa·s, more preferably from 70 mPa·s to 500 mPa·s, most preferably from 100 mPa·s to 450 mPa·s (see Methods).

To maintain phase stability of the liquid fabric softener composition, the dynamic yield stress (see Methods) at 20° C. of the liquid fabric softener composition may be from 0.001 Pa to 1.0 Pa, preferably from 0.005 Pa to 0.8 Pa, more preferably from 0.010 Pa to 0.5 Pa. The absence of a sufficiently high dynamic yield stress may lead to phase instabilities such as particle creaming or settling in case the liquid fabric softener composition comprises suspended particles or encapsulated benefit agents. Higher dynamic yield stresses may lead to undesired air entrapment during filling of a packaging with the liquid fabric softener composition.

### Process to Make a Liquid Fabric Softener Composition

It has been found that the process to make a liquid fabric softener composition in accordance with the present disclosure allows for reduced manufacturing complexity, and hence cost, whilst providing for a product having satisfactory properties, such as for example, phase stability, softness, a pleasant smell, and improved, rich appearance, which are consumer preferred. In sum, the solution can be to manufacture a concentrated fabric softener premix comprising from 8% to 35% of a quaternary ammonium ester softening active, and comprising microfibrous cellulose, diluting said concentrated fabric softener premix with an aqueous dilution medium to form a liquid fabric softener composition comprising from 3% to 17% of a quaternary ammonium ester softening active and 0.01% to 5% of microfibrous cellulose, wherein the liquid fabric softener composition comprises at most 90% by weight of the composition of said concentrated fabric softener premix. Preferably, the liquid fabric softener comprises by weight of the composition at most 80%, preferably 20% to 75%, more preferably 30% to 70%, most preferably 35% to 65% of said concentrated fabric softener premix.

To further reduce manufacturing complexity and cost, the concentrated fabric softener premix is preferably diluted with an aqueous medium at a temperature of 5° C. to 90° C., preferably 8° C. to 60° C., more preferably 10° C. to 40° C., even more preferably 10° C. to 30° C., most preferably ambient temperature. Indeed, it is an added expense to chill or heat the aqueous medium prior to the dilution step.

The aqueous medium may comprise salt. Examples of suitable salts include CaCl₂, NaCl, MgCl₂, and chelating salts such NaHEDP (sodium salt of 1-Hydroxy Ethylidene-1,1-Diphosphonic Acid) and DTPA (diethylenetriaminepentaacetic acid). The aqueous medium may comprise materials dispersed in the aqueous medium to further improve the viscosity and phase stability, freshness performance, and softness performance. Example of such materials include dispersed perfumes, encapsulated benefit agent, thickeners, fabric softening actives, dyes, and mixtures thereof. Preferably, the level of materials dispersed into the aqueous medium is less than 6%, more preferably less than 3%, even more preferably less than 1%, most preferably less than 0.1% by weight of the aqueous medium. Preferably, the aqueous medium comprises thickener at a level less than 0.01%, preferably less than 0.001% by weight of the aqueous medium. Low levels of materials dispersed into the aqueous medium further reduces manufacturing complexity to prepare the aqueous medium. Furthermore, dispersed material in the aqueous medium may negatively affect the softness or freshness performance as well as the viscosity and phase stability of the liquid fabric softener composition.

To minimize microbial activity, the aqueous medium may comprise an antibacterial compound. An example of a commercially available suitable antibacterial compound is Proxel™ GXL supplied by Lonza.

To improve the hydrolytic stability of the final liquid fabric softener composition, the aqueous medium may have a pH between 2 and 7, preferably between 2 and 5, more preferably between 2 and 3.5, most preferably between 2 and 3.

Preferably the aqueous medium is an aqueous solution. Preferably the aqueous medium has a conductivity at 20° C. less than 7 mS/cm, preferably less than 6 mS/cm, more preferably between less than 2 mS/cm, most preferably less than 1 mS/cm. Aqueous media with a lower conductivity result in a liquid fabric softener composition with a higher viscosity, and hence richer appearance upon dilution of the concentrated fabric softener premix.

The dilution step may be a multiple stage process and may comprise multiple dilutions with water and optionally adjunct materials, and the different stages may be performed at some time after the initial dilution to enable late product differentiation and customization. Preferably, the dilution step is a single process in a batch wise process or, preferably, is conducted in-line. The term “in-line” means that two pipes converge wherein the first pipe pipes concentrated fabric softener premix and wherein the second pipe pipes the aqueous dilution medium. A static mixer or other type of mixing apparatus may be added after the concentrated fabric softener premix and aqueous medium converge to facilitate mixing.

### Quaternary Ammonium Ester Softening Active

The concentrated fabric softener premix of the present invention comprises quaternary ammonium ester softening active (Fabric Softening Active, “FSA”) at a level from 8% to 35%, preferably from 8% to 25%, more preferably from 10% to 25% by weight of the composition.

The liquid fabric softener composition of the present invention comprises quaternary ammonium ester softening active (Fabric Softening Active, “FSA”) at a level from 3% to 17% by weight of the composition, to provide softness to treated fabrics. In preferred liquid fabric softener compositions, the quaternary ammonium ester softening active is present at a level of from 3% to 15%, more preferably from 5% to 15%, most preferably from 5% to 12% by weight of the composition. The level of quaternary ammonium ester softening active may depend on the desired concentration of the total softening active in the composition (i.e., diluted or concentrated composition). The level of quaternary ammonium ester softening active may also depend on the presence or absence of other softening active(s).

Suitable quaternary ammonium ester softening actives include, but are not limited to, materials selected from the group consisting of monoester quats, diester quats, triester quats and mixtures thereof. Preferably, the level of monoester quat is from 2.0% to 40.0%, the level of diester quat is from 40.0% to 98.0%, the level of triester quat is from 0.0% to 25.0% by weight of total quaternary ammonium ester softening active.

Said quaternary ammonium ester softening active may comprise compounds of the following formula:

{R²₍₄₋ₘ₎—N+—[X—Y—R¹]ₘ}A-

wherein:
m is 1, 2 or 3 with proviso that the value of each m is identical;
each R¹ is independently hydrocarbyl, or branched hydrocarbyl group, preferably R¹ is linear, more preferably R¹ is partially unsaturated linear alkyl chain;
each R² is independently a C₁-C₃ alkyl or hydroxyalkyl group, preferably R² is selected from methyl, ethyl, propyl, hydroxyethyl, 2-hydroxypropyl, 1-methyl-2-hydroxyethyl, poly(C₂₋₃ alkoxy), polyethoxy, benzyl;
each X is independently —(CH₂)ₙ—, —CH₂—CH(CH₃)— or —CH(CH₃)—CH₂— and
each n is independently 1, 2, 3 or 4, preferably each n is 2;
each Y is independently —O—(O)C— or —C(O)—O—;
A- is independently selected from the group consisting of chloride, methyl sulfate, and ethyl sulfate, preferably A- is selected from the group consisting of chloride and methyl sulfate;

with the proviso that when Y is —O—(O)C—, the sum of carbons in each R¹ is from 13 to 21, preferably from 13 to 19. Preferably, X is —CH₂—CH(CH₃)— or —CH(CH₃)—CH₂— to further improve the hydrolytic stability of the quaternary ammonium ester softening active, and hence further improve the stability of the liquid fabric softener composition.

Because of the balance of processability and odor of the quaternary ammonium ester softening active, in preferred liquid fabric softener compositions, the iodine value of the parent fatty acid from which the quaternary ammonium fabric softening active is formed is from 0 to 100, more preferably from 10 to 60, even more preferably from 15 to 45.

Examples of suitable quaternary ammonium ester softening actives are commercially available from KAO Chemicals under the trade name Tetranyl® AT-1 and Tetranyl® AT-7590, from Evonik under the tradename Rewoquat® WE16 DPG, Rewoquat® WE18, Rewoquat® WE20, Rewoquat® WE28, and Rewoquat® 38 DPG, from Stepan under the tradename Stepantex® GA90, Stepantex® VR90, Stepantex® VK90, Stepantex® VA90, Stepantex® DC90, and Stepantex® VL90A.

These types of agents and general methods of making them are disclosed in U.S. Pat. No. 4,137,180.

### Microfibrous Cellulose:

The concentrated fabric softener premix of the present invention comprises microfibrous cellulose, preferably at a level of from 0.02% to 10.0%, more preferably from 0.04% to 6% by weight of the premix.

The liquid fabric softener composition of the present invention comprises microfibrous cellulose at a level of from 0.01% to 5.0% by weight of the composition. Microfibrous cellulose thickens, and improves the phase stability of the liquid fabric softener composition. It was surprisingly found that the viscosity decrease is smaller upon dilution of a concentrated fabric softener premix comprising microfibrous cellulose according to the present invention as compared to concentrated fabric softener premix comprising conventional thickeners such as cationic polymers. Moreover, microfibrous cellulose structures the liquid fabric softener compositions which enables suspension of particles such as benefit agent encapsulates to provide additional benefits to treated fabrics.

Preferably, the composition of the present invention comprises from 0.05% to 1.0%, more preferably from 0.1% to 0.75%, even more preferably from 0.2% to 0.6% of microfibrous cellulose by weight of the composition.

By microfibrous cellulose it is meant herein cellulose micro fibrils. The microfibrous cellulose can be of bacterial or botanical origin, i.e. produced by fermentation or extracted from vegetables, plants, fruits or wood. Microfibrous cellulose sources may be selected from the group consisting of citrus peels, such as lemons, oranges and/or grapefruit; apples, bananas and/or pear; vegetables such as carrots, peas, potatoes and/or chicory; plants such as bamboo, jute, abaca, flax, cotton and/or sisal, cereals, and different wood sources such as spruces, eucalyptus and/or oak. Preferably, the microfibrous cellulose source is selected from the group consisting of wood or plants, in particular, spruce, eucalyptus, jute, and sisal. The most preferred microfibrous cellulose source is wood, preferably from spruce or eucalyptus.

The content of cellulose in the microfibrous cellulose will vary depending on the source and treatment applied for the extraction of the fibers, and will typically range from 15% to 100%, preferably above 30%, more preferably above 50%, and even more preferably above 80% of cellulose by weight of the microfibrous cellulose.

Such microfibrous cellulose may comprise pectin, hemicellulose, proteins, lignin and other impurities inherent to the cellulose based material source such as ash, metals, salts and combinations thereof. The microfibrous cellulose is preferably non-ionic. Such microfibrous cellulose materials are commercially available, for instance Citri-Fi 100FG from Fiberstar, Herbacel® Classic from Herbafood, and Exilva® from Borregaard.

To further improve the phase stability, the microfibrous cellulose may have an average diameter (see Methods) from 10 nm to 350 nm, preferably from 30 nm to 250 nm, more preferably from 50 nm to 200 nm.

### Non-Ionic Surfactants

The concentrated fabric softener premix may comprise non-ionic surfactants. The liquid fabric softener composition may comprise from 0.01% to 5.0%, preferably from 0.1% to 3.0%, more preferably from 0.5% to 2.0% of non-ionic surfactant based on the total fabric softener composition weight. Non-ionic surfactants further improve the viscosity stability when the liquid fabric softener composition has been exposed to freezing temperatures. Very high levels (e.g., 5% or above) of non-ionic surfactant may lead to phase instabilities.

In preferred liquid fabric softener compositions, the ratio by weight of quaternary ammonium ester softening active to non-ionic surfactant is from 3:1 to 500:1, preferably from 5:1 to 50:1, more preferably from 10:1 to 40:1.

In preferred liquid fabric softener compositions, the non-ionic surfactant is an alkoxylated non-ionic surfactant, preferably an ethoxylated non-ionic surfactant. Preferably the alkoxylated non-ionic surfactant has an average degree of alkoxylation of at least 3, preferably from 5 to 100, more preferably from 10 to 60.

Preferably the alkoxylated non-ionic surfactant is an ethoxylated non-ionic surfactant, more preferably an ethoxylated non-ionic surfactant having a hydrophobic lipophilic balance value of 8 to 18.

Examples of suitable non-ionic surfactants are commercially available from BASF under the tradename Lutensol® AT80 (ethoxylated alcohol with an average degree of ethoxylation of 80 from BASF), from Clariant under the tradename Genapol® T680 (ethoxylated alcohol with an average degree of ethoxylation of 68), from Sigma Aldrich under the tradename Tween® 20 (polysorbate with an average degree of ethoxylation of 20), from The Dow Chemical Company under the tradename Tergitol™ 15-S-30 (ethoxylated branched alcohol with an average degree of ethoxylation of 30), from Clariant under trade name Genapol® X407 (ethoxylated branched alcohol with an average degree of ethoxylation of 40).

### Dispersed Perfume

To further reduce manufacturing complexity, dispersed perfume is preferably present in the concentrated fabric softener premix prior to dilution to liquid fabric softener composition. The concentrated fabric softener premix may comprise dispersed perfume at a level of from 0.15% to 6%, preferably from 0.2% to 5%, more preferably from 0.5% to 4% of dispersed perfume.

The liquid fabric softener composition of the present invention may comprise dispersed perfume composition at a level of from 0.1% to 5.0% by weight of the composition. Dispersed perfume is typically added to provide the liquid fabric softener composition with a pleasant smell. Dispersed perfume increases the tendency of the liquid fabric softener composition to exhibit phase instabilities.

By dispersed perfume we herein mean a perfume composition that is freely dispersed in the liquid fabric softener composition and is not encapsulated. A perfume composition comprises one or more perfume raw materials. Perfume raw materials are the individual chemical compounds that are used to make a perfume composition. The choice of type and number of perfume raw materials is dependent upon the final desired scent. In the context of the present invention, any suitable perfume composition may be used. Those skilled in the art will recognize suitable compatible perfume raw materials for use in the perfume composition, and will know how to select combinations of ingredients to achieve desired scents.

Preferably, the level of dispersed perfume is at a level of from 0.2% to 4.0%, more preferably from 0.3% to 4.0%, even more preferably from 0.4% to 3.5% by total weight of the fabric softener composition.

The perfume composition may comprise from 2.5% to 30%, preferably from 5% to 30% by total weight of perfume composition of perfume raw materials characterized by a logP lower than 3.0, and a boiling point lower than 250° C.

The perfume composition may comprise from 5% to 30%, preferably from 7% to 25% by total weight of perfume composition of perfume raw materials characterized by having a logP lower than 3.0 and a boiling point higher than 250° C. The perfume composition may comprise from 35% to 60%, preferably from 40% to 55% by total weight of perfume composition of perfume raw materials characterized by having a logP higher than 3.0 and a boiling point lower than 250° C. The perfume composition may comprise from 10% to 45%, preferably from 12% to 40% by total weight of perfume composition of perfume raw materials characterized by having a logP higher than 3.0 and a boiling point higher than 250° C.

### Particles

The liquid fabric softener composition of the present invention may also comprise particles. The liquid fabric softener composition may comprise, based on the total liquid fabric softener composition weight, from 0.02% to 10%, preferably from 0.1% to 4%, more preferably from 0.25% to 2.5% of particles. Said particles include beads, pearlescent agents, encapsulated benefit agent, and mixtures thereof.

### Encapsulated Benefit Agent:

The liquid fabric softener composition may comprise from 0.05% to 8%, preferably from 0.05% to 3%, more preferably from 0.05% to 2% by weight of encapsulated benefit agent. The benefit agent is selected from the group consisting of perfume composition, moisturizers, a heating or cooling agent, an insect/moth repellent, germ/mould/mildew control agents, softening agents, antistatic agents, anti-allergenic agents, UV protection agents, sun fade inhibitors, hueing dyes, enzymes, color protection agents such as dye transfer inhibitors, bleach agents, and combinations thereof. Perfume compositions are preferred.

The benefit agent is encapsulated, for instance, as part of a core in one or more capsules. Such cores can comprise other materials, such as diluents, solvents and density balancing agents.

The capsules have a wall, which at least partially, preferably fully surrounds the benefit agent comprising core. The capsule wall material may be selected from the group consisting of melamine, polyacrylamide, silicones, silica, polystyrene, polyurea, polyurethanes, polyacrylate based materials, polyacrylate esters based materials, gelatin, styrene maleic anhydride, polyamides, aromatic alcohols, polyvinyl alcohol, resorcinol-based materials, poly-isocyanate-based materials, acetals (such as 1,3,5-triol-benzene-gluteraldehyde and 1,3,5-triol-benzene melamine), starch, cellulose acetate phthalate and mixtures thereof.

Preferably, the capsule wall comprises one or more wall materials comprising melamine, polyacrylate based material and combinations thereof.

Said melamine wall material may be selected from the group consisting of melamine crosslinked with formaldehyde, melamine-dimethoxyethanol crosslinked with formaldehyde, and combinations thereof.

Said polyacrylate based material may be selected from the group consisting of polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer and combinations thereof.

Said polystyrene wall material may be selected from polystyrene cross-linked with divinylbenzene.

Polyurea capsules can comprise a polyurea wall which is the reaction product of the polymerisation between at least one polyisocyanate comprising at least two isocyanate functional groups and at least one amine, preferably a polyfunctional amine as a cross-linking and a colloidal stabilizer.

Polyurethane capsules can comprise a polyureathane wall which is the reaction product of a polyfunctional isocyanate and a polyfunctional alcohol as a cross-linking agent and a colloidal stabilizer.

Suitable capsules can be obtained from Encapsys (Appleton, Wis., USA). The liquid fabric softener compositions may comprise combinations of different capsules, for example capsules having different wall materials and/or benefit agents.

As mentioned earlier, perfume compositions are the preferred encapsulated benefit agent. The encapsulated perfume composition comprises perfume raw materials. The encapsulated perfume composition can further comprise essential oils, malodour reducing agents, odour controlling agents and combinations thereof.

The perfume raw materials are typically present in an amount of from 10% to 95%, preferably from 20% to 90% by weight of the capsule.

The perfume composition may comprise from 2.5% to 30%, preferably from 5% to 30% by total weight of perfume composition of perfume raw materials characterized by a logP lower than 3.0, and a boiling point lower than 250° C.

The perfume composition may comprise from 5% to 30%, preferably from 7% to 25% by total weight of perfume composition of perfume raw materials characterized by having a logP lower than 3.0 and a boiling point higher than 250° C. The perfume composition may comprise from 35% to 60%, preferably from 40% to 55% by total weight of perfume composition of perfume raw materials characterized by having a logP higher than 3.0 and a boiling point lower than 250° C. The perfume composition may comprise from 10% to 45%, preferably from 12% to 40% by total weight of perfume composition of perfume raw materials characterized by having a logP higher than 3.0 and a boiling point higher than 250° C.

If present, to further reduce manufacturing complexity, the encapsulated benefit agent is preferably added to the concentrated fabric softener premix prior to dilution to liquid fabric softener composition.

### Ratio of Encapsulated Benefit Agent to Dispersed Perfume Oil

The liquid fabric softener composition may comprise a ratio by weight of encapsulated perfume oil to dispersed perfume oil of from 1:1 to 1:40, preferably from 1:2 to 1:20, more preferably from 1:3 to 1:10 to improve the balance of the pleasant smell of treated fabrics at the wet and the dry stages.

### Additional Fabric Softening Active

The liquid fabric softener composition of the present invention may comprise from 0.01% to 10%, preferably from 0.1% to 10%, more preferably from 0.1% to 5% of additional fabric softening active. Suitable fabric softening actives, include, but are not limited to, materials selected from the group consisting of non-ester quaternary ammonium compounds, amines, fatty esters, sucrose esters, silicones, dispersible polyolefins, polysaccharides, fatty acids, softening oils, polymer latexes and combinations thereof.

Non-limiting examples of non-ester quaternary ammonium compounds include dialkylenedimethylammonium salts such as dicanoladimethylammonium chloride, di(hard)tallowdimethylammonium chloride dicanoladimethylammonium methylsulfate, and mixtures thereof. Non-limiting examples of commercially available dialkylenedimethylammonium salts usable in the present invention is dioleyldimethylammonium chloride available from Witco Corporation under the trade name Adogen® 472 and dihardtallow dimethylammonium chloride available from Akzo Nobel under the tradename Arquad® 2HT75.

### Amines:

Suitable amines include but are not limited to, materials selected from the group consisting of amidoesteramines, amidoamines, imidazoline amines, alkyl amines, and combinations thereof. Suitable ester amines include but are not limited to, materials selected from the group consisting of monoester amines, diester amines, triester amines and combinations thereof. Suitable amidoamines include but are not limited to, materials selected from the group consisting of monoamido amines, diamido amines and combinations thereof. Suitable alkyl amines include but are not limited to, materials selected from the group consisting of mono alkylamines, dialkyl amines quats, trialkyl amines, and combinations thereof.

### Fatty Acid:

The liquid fabric softener composition may comprise a fatty acid, such as a free fatty acid as fabric softening active. The term “fatty acid” is used herein in the broadest sense to include unprotonated or protonated forms of a fatty acid. One skilled in the art will readily appreciate that the pH of an aqueous composition will dictate, in part, whether a fatty acid is protonated or unprotonated. The fatty acid may be in its unprotonated, or salt form, together with a counter ion, such as, but not limited to, calcium, magnesium, sodium, potassium, and the like. The term “free fatty acid” means a fatty acid that is not bound to another chemical moiety (covalently or otherwise).

The fatty acid may have an iodine value from 0 to 140, from 50 to 120 or even from 85 to 105.

### Polysaccharides:

The liquid fabric softener composition may comprise a polysaccharide as a fabric softening active, such as cationic starch. Suitable cationic starches for use in the present compositions are commercially-available from Cerestar under the trade name C*BOND® and from National Starch and Chemical Company under the trade name CATO® 2A.

### Sucrose Esters:

The liquid fabric softener composition may comprise a sucrose esters as a fabric softening active. Sucrose esters are typically derived from sucrose and fatty acids. Sucrose ester is composed of a sucrose moiety having one or more of its hydroxyl groups esterified.

### Silicone:

The liquid fabric softener composition may comprise a silicone as fabric softening active. Useful silicones can be any silicone comprising compound. The silicone polymer may be selected from the group consisting of cyclic silicones, polydimethylsiloxanes, aminosilicones, cationic silicones, silicone polyethers, silicone resins, silicone urethanes, and combinations thereof. The silicone may be a polydialkylsilicone, alternatively a polydimethyl silicone (polydimethyl siloxane or “PDMS”), or a derivative thereof. The silicone may be chosen from an aminofunctional silicone, amino-polyether silicone, alkyloxylated silicone, cationic silicone, ethoxylated silicone, propoxylated silicone, ethoxylated/propoxylated silicone, quaternary silicone, or combinations thereof.

If present, to further reduce manufacturing complexity, additional fabric softening active is preferably added to the concentrated fabric softener premix prior to dilution to liquid fabric softener composition.

### Further Perfume Delivery Technologies

The liquid fabric softener composition may comprise one or more perfume delivery technologies that stabilize and enhance the deposition and release of perfume ingredients from treated substrate. Such perfume delivery technologies can be used to increase the longevity of perfume release from the treated substrate. Perfume delivery technologies, methods of making certain perfume delivery technologies and the uses of such perfume delivery technologies are disclosed in US 2007/0275866 A 1.

The liquid fabric softener composition may comprise from 0.001% to 20%, or from 0.01% to 10%, or from 0.05% to 5%, or even from 0.1% to 0.5% by weight of the perfume delivery technology. Said perfume delivery technologies may be selected from the group consisting of: pro-perfumes, cyclodextrins, starch encapsulated accord, zeolite and inorganic carrier, and combinations thereof.

### Deposition Aid

The liquid fabric softener composition may comprise, based on the total liquid fabric softener composition weight, from 0.0001% to 3%, preferably from 0.0005% to 2%, more preferably from 0.001% to 1% of a deposition aid. The deposition aid may be a cationic or amphoteric polymer. The cationic polymer may comprise a cationic acrylate. Cationic polymers in general and their method of manufacture are known in the literature. Deposition aids can be added concomitantly with particles or directly in the liquid fabric softener composition. Preferably, the deposition aid is selected from the group consisting of polyvinylformamide, partially hydroxylated polyvinylformamide, polyvinylamine, polyethylene imine, ethoxylated polyethylene imine, polyvinylalcohol, polyacrylates, and combinations thereof.

The weight-average molecular weight of the polymer may be from 500 to 5,000,000 Dalton or from 1,000 to 2,000,000 Dalton or from 2,500 to 1,500,000 Dalton, as determined by size exclusion chromatography relative to polyethyleneoxide standards using Refractive Index (RI) detection. In one aspect, the weight-average molecular weight of the cationic polymer may be from 500 to 37,500 Dalton.

### Dyes and Pigments

The concentrated fabric softener premix and liquid fabric softener composition may comprise adjunct ingredients suitable for use in the instant compositions and may be desirably incorporated in certain aspects of the invention, for example to improve the aesthetics of the composition as is the case with pigments and dyes. Moreover, liquid fabric softener compositions comprising unsaturated quaternary ammonium ester softening actives are subject to some degree of UV light and/or oxidation which increases the risk on yellowing of the liquid fabric softener composition as well as yellowing of treated fabrics. However, especially in the presence of a dye phase instabilities become more apparent. The liquid fabric softener composition may comprise from 0.0001% to 0.1%, preferably from 0.001% to 0.05% of a dye by weight of the composition. Suitable dyes are selected from the list comprising bis-azo dyes, tris-azo dyes, acid dyes, azine dyes, hydrophobic dyes, methane basic dyes, anthraquinone basic dyes, and dye conjugates formed by binding acid or basic dyes to polymers.

### Methods

### Method to Determine Conductivity of Aqueous Solution

The conductivity of an aqueous solution, expressed in mili Siemens/cm (mS/cm) or micro Siemens/cm (μS/cm), is determined at 20-25° C. using an electrical conductivity probe (such as Mettler Toledo InLab 730 probe) calibrated according to the instructions manual.

### Method of Determining pH of a Fabric Softener Composition

The pH is measured on the neat fabric softener composition, using a Sartorius PT-10P pH meter with gel-filled probe (such as the Toledo probe, part number 52 000 100), calibrated according to the instructions manual.

### Method of Determining Viscosity of a Fabric Softener Composition

The viscosity of neat fabric softener composition is determined using a Brookfield DV-E rotational viscometer, at 60 rpm, at 21° C. Spindle 2 is used for viscosities from 50 mPa·s to 400 mPa·s. Spindle 3 is used for viscosities from 401 mPa·s to 2.0 Pa·s. Spindle 4 is used for viscosities greater than 2.0 Pa·s.

### Method for Determining Dynamic Yield Stress

Dynamic yield stress is measured using a controlled stress rheometer (such as an HAAKE MARS from Thermo Scientific, or equivalent), using a 60 mm parallel plate and a gap size of 500 microns at 20° C. The dynamic yield stress is obtained by measuring quasi steady state shear stress as a function of shear rate starting from 10 s⁻¹ to 10⁻⁴ s⁻¹, taking 25 points logarithmically distributed over the shear rate range. Quasi-steady state is defined as the shear stress value once variation of shear stress over time is less than 3%, after at least 30 seconds and a maximum of 60 seconds at a given shear rate. Variation of shear stress over time is continuously evaluated by comparison of the average shear stress measured over periods of 3 seconds. If after 60 seconds measurement at a certain shear rate, the shear stress value varies more than 3%, the final shear stress measurement is defined as the quasi state value for calculation purposes. Shear stress data is then fitted using least squares method in logarithmic space as a function of shear rate following a Herschel-Bulkley model:

τ=τ₀+k\dot{γ}ⁿ

wherein τ is the measured equilibrium quasi steady state shear stress at each applied shear rate \dot{γ}, τ₀ is the fitted dynamic yield stress. k and n are fitting parameters.

### Method of Measuring Iodine Value of a Quaternary Ammonium Ester Fabric Softening Active:

The iodine value of a quaternary ammonium ester fabric softening active is the iodine value of the parent fatty acid from which the fabric softening active is formed, and is defined as the number of grams of iodine which react with 100 grams of parent fatty acid from which the fabric softening active is formed.

First, the quaternary ammonium ester fabric softening active is hydrolysed according to the following protocol: 25 g of fabric softener composition is mixed with 50 mL of water and 0.3 mL of sodium hydroxide (50% activity). This mixture is boiled for at least an hour on a hotplate while avoiding that the mixture dries out. After an hour, the mixture is allowed to cool down and the pH is adjusted to neutral (pH between 6 and 8) with sulfuric acid 25% using pH strips or a calibrated pH electrode.

Next the fatty acid is extracted from the mixture via acidified liquid-liquid extraction with hexane or petroleum ether: the sample mixture is diluted with water/ethanol (1:1) to 160 mL in an extraction cylinder, 5 grams of sodium chloride, 0.3 mL of sulfuric acid (25% activity) and 50 mL of hexane are added. The cylinder is stoppered and shaken for at least 1 minute. Next, the cylinder is left to rest until 2 layers are formed. The top layer containing the fatty acid in hexane is transferred to another recipient. The hexane is then evaporated using a hotplate leaving behind the extracted fatty acid.

Next, the iodine value of the parent fatty acid from which the fabric softening active is formed is determined following ISO3961:2013. The method for calculating the iodine value of a parent fatty acid comprises dissolving a prescribed amount (from 0.1-3 g) into 15 mL of chloroform. The dissolved parent fatty acid is then reacted with 25 mL of iodine monochloride in acetic acid solution (0.1M). To this, 20 mL of 10% potassium iodide solution and 150 mL deionised water is added. After the addition of the halogen has taken place, the excess of iodine monochloride is determined by titration with sodium thiosulphate solution (0.1M) in the presence of a blue starch indicator powder. At the same time a blank is determined with the same quantity of reagents and under the same conditions. The difference between the volume of sodium thiosulphate used in the blank and that used in the reaction with the parent fatty acid enables the iodine value to be calculated.

### Method of Measuring Fatty Acid Chain Length Distribution

The fatty acid chain length distribution of the quaternary ammonium ester fabric softening active refers to the chain length distribution of the parent fatty acid from which the fabric softening active is formed. It can be measured on the quaternary ammonium ester softening active or on the fatty acid extracted from the fabric softener composition as described in the method to determine the iodine value of a quaternary ammonium ester fabric softening active. The fatty acid chain length distribution is measured by dissolving 0.2 g of the quaternary ammonium ester softening active or extracted fatty acid in 3 mL of 2-butanol, 3 glass beads are added and the sample is vortexed at high speed for 4 minutes. An aliquot of this extract is then transferred into a 2 mL gas chromatography vial, which is then injected into the gas chromatogram inlet (250° C.) of the gas chromatograph (Agilent GC6890N) and the resultant bi-products are separated on a DB-5ms column (30 m×250 μm×1.0 μm, 2.0 mL/min). These bi-products are identified using a mass-spectrometer (Agilent MSD5973N, Chemstation Software version E.02.02) and the peak areas of the corresponding fatty acid chain lengths are measured. The fatty acid chain length distribution is determined by the relative ratios of the peak areas corresponding to each fatty acid chain length of interest as compared to the sum of all peaks corresponding to all fatty acid chain lengths.

### Method for Determining Average Cellulose Fiber Diameter:

The average cellulose fiber diameter can be determined directly from the cellulose fiber raw material or from the fabric softener composition comprising cellulose fibers.
A) Cellulose fibers raw material: A cellulose fibers sample is prepared by adding 1% dry matter of cellulose fibers to water and activating it with a high pressure homogenizer (PANDA from GEA, 350 bars, 10 passes). The obtained sample is analyzed.
B) Fabric softener composition comprising cellulose fibers:

The fabric softener composition sample is centrifuged at 4,000 rpm for 10 minutes using a 5804 centrifuge from Eppendorf, in order to remove potential particles to avoid interference in the measurement of the fiber size. The clarified fabric softener composition is then decanted as the supernatant. The cellulose fibers present in the fabric softener composition (supernatant) are redispersed in ethanol using an Ultra Turrax device from IKA, T25 S 25 N-25 G-ST, at a speed of 21 000 rpm for 10 minutes. Then, sample is centrifuged at 4 000 rpm for 10 minutes using a 5804 centrifuge from Eppendorf and supernatant is removed. Remaining cellulose fibers at the bottom are analyzed. The process is repeated as many times as needed to have enough amount for the analysis.

Average cellulose fiber diameter is analysed using Atomic force microscopy (AFM). A 0.02% cellulose fiber dispersion in demineralized water is prepared, and a drop of this dispersion is deposited onto freshly cleaved mica (highest grade V1 Mica, 15×15mm—TED PELLA, INC., or equivalent). The sample is then allowed to dry in an oven at 40° C.

The mica sheet is mounted in an AFM (Nanosurf Flex AFM, ST Instruments or equivalent) and imaged in air under ambient conditions using a Si cantilever in dynamic mode with dynamic mode tip (ACTA-50—APPNANO or equivalent). The image dimensions are 20 micron by 20 micron, and 256 points per line are captured.

The AFM image is opened using suitable AFM data analysis software (such as Mountainsmap SPM 7.3, ST Instruments, or equivalent). Each image is leveled line by line. One or more profiles are extracted crossing perpendicularly one or multiple fibers avoiding bundles of fibers, and from each profile, a distance measurement is performed to obtain the diameter of the fibers. Ten diameter measurements are performed per picture counting each fiber only once.

Three sets of measurements (sample preparation, AFM measurement and image analysis) are made. The arithmetic mean of all fibers measured in all images is the Average Cellulose Fiber Diameter.

### Method of Determining Partition Coefficient

The partition coefficient, P, is the ratio of concentrations of a compound in a mixture of two immiscible phases at equilibrium, in this case n-Octanol/Water. The value of the log of the n-Octanol/Water Partition Coefficient (logP) can be measured experimentally using well known means, such as the “shake-flask” method, measuring the distribution of the solute by UV/VIS spectroscopy (for example, as described in “The Measurement of Partition Coefficients”, Molecular Informatics, Volume 7, Issue 3, 1988, Pages 133-144, by Dearden J C, Bresnan). Alternatively, the logP can be computed for each PRM in the perfume mixture being tested. The logP of an individual PRM is preferably calculated using the Consensus logP Computational Model, version 14.02 (Linux) available from Advanced Chemistry Development Inc. (ACD/Labs) (Toronto, Canada) to provide the unitless logP value. The ACD/Labs' Consensus logP Computational Model is part of the ACD/Labs model suite.

### Processes of Making a Concentrated Fabric Softener Premix

Concentrated Fabric softener premixes can be formulated into any suitable form and prepared by any process chosen by the formulator, non-limiting examples of which are described in Applicant's examples and in US 2013/0109612 A1 which is incorporated herein by reference.

The concentrated Fabric softener premixes disclosed herein may be prepared by combining the components thereof in any convenient order and by mixing, e.g., agitating, the resulting component combination to form a phase stable fabric care composition. A fluid matrix may be formed containing at least a major proportion, or even substantially all, of the fluid components with the fluid components being thoroughly admixed by imparting shear agitation to this liquid combination. For example, rapid stirring with a mechanical stirrer may be employed.

The concentrated Fabric softener premixes described herein can also be made as follows:

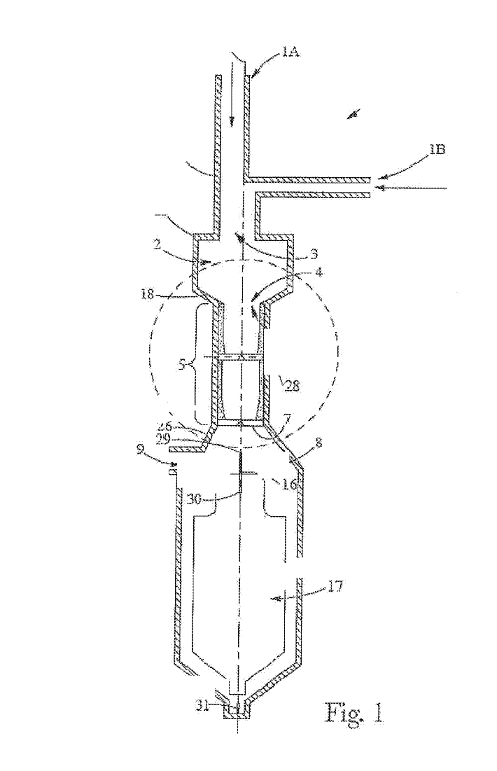

Taking an apparatus A (see FIG. 1) comprising:

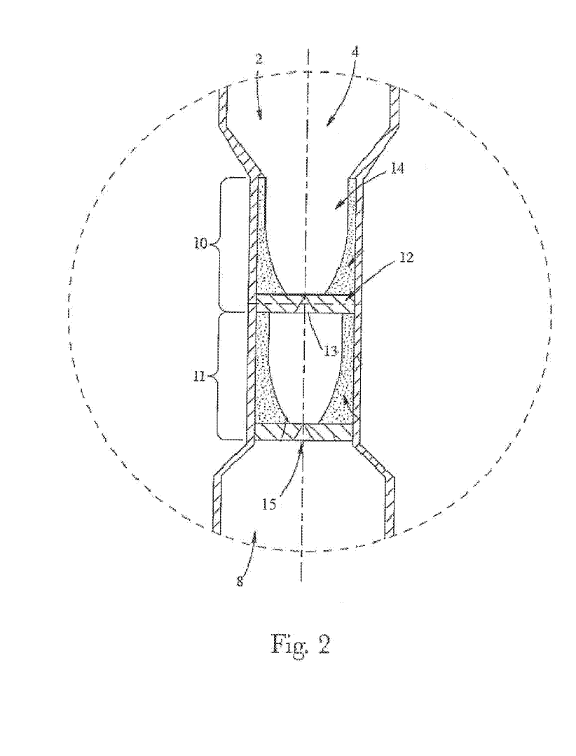

at least a first inlet (1A) and a second inlet (1B); a pre-mixing chamber (2), the pre-mixing chamber (2) having an upstream end (3) and a downstream end 4, the upstream end (3) of the pre-mixing chamber (2) being in liquid communication with the first inlet 1A and the second inlet 1B; an orifice component (5), the orifice component (5) having an upstream end (6) and a downstream end (7), the upstream end of the orifice component (6) being in liquid communication with the downstream end (4) of the pre-mixing chamber (2), wherein the orifice component (5) is configured to spray liquid in a jet and produce shear and/or turbulence in the liquid; a secondary mixing chamber (8), the secondary mixing chamber (8) being in liquid communication with the downstream end (7) of the orifice component (5); at least one outlet (9) in liquid communication with the secondary mixing chamber (8) for discharge of liquid following the production of shear and/or turbulence in the liquid, the inlet 1A, pre-mixing chamber (2), the orifice component (5) and secondary mixing chamber (8) are linear and in straight line with each other, at least one outlet (9) being located at the downstream end of the secondary mixing chamber (8); the orifice component (5) comprising at least one orifice unit, a specific example, as shown in FIG. 2, is that the orifice component (5) comprises two orifice units (10) and (11) arranged in series to one another and each orifice unit comprises an orifice plate (12) comprising at least one orifice (13), an orifice chamber (14) located upstream from the orifice plate (12) and in liquid communication with the orifice plate (12); and wherein neighboring orifice plates are distinct from each other;

connecting one or more suitable liquid pumping devices to the first inlet 1A and to the second inlet 1B;

pumping a second liquid composition into the first inlet 1A, and, pumping a liquid fabric softener active composition into the second inlet 1B, wherein the operating pressure of the apparatus is from 2.5 bar to 50 bar, from 3.0 bar to 20 or from 3.5 bar to 10 bar the operating pressure being the pressure of the liquid as measured in the first inlet 1A near to inlet 1B. The operating pressure at the outlet of apparatus A needs to be high enough to prevent cavitation in the orifice;

allowing the liquid fabric softener active and the second liquid composition to pass through the apparatus A at a desired flow rate, wherein as they pass through the apparatus A, they are dispersed one into the other, herein, defined as a liquid fabric softener intermediate.

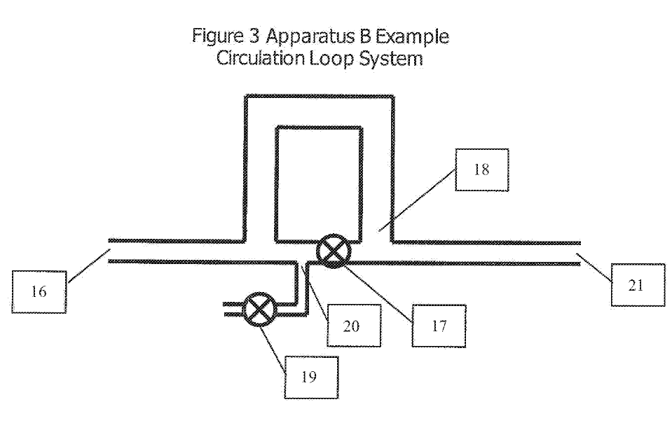

passing said liquid fabric softener intermediate from Apparatus A's outlet, to Apparatus B's (FIG. 3) inlet (16) to subject the liquid fabric softener intermediate to additional shear and/or turbulence for a period of time within Apparatus B.

circulating said liquid fabric softener intermediate within apparatus B with a circulation Loop pump (17) at a Circulation Loop (18) Flow Rate equal to or greater than said inlet liquid fabric softener intermediate flow rate in said Circulation Loop System. A tank, with or without a recirculation loop, or a long conduit may also be employed to deliver the desired shear and/or turbulence for the desired time.

adding by means of a pump (19), piping and in-line fluid injector (20), an adjunct fluid, in one aspect, but not limited to a dilute salt solution, into Apparatus B to mix with the liquid fabric softener intermediate

allowing the liquid fabric softener composition with the desired microstructure to exit Apparatus B (21) at a rate equal to the inlet flow rate into Apparatus B.

passing said liquid fabric softener composition exiting Apparatus B outlet through a heat exchanger to be cooled to ambient temperature, if necessary.

discharging the resultant liquid fabric softener composition produced out of the outlet of the process.

The process comprises introducing, in the form of separate streams, the fabric softener active in a liquid form and a second liquid composition comprising other components of a fabric softener composition into the pre-mixing chamber 2 of Apparatus A so that the liquids pass through the orifice component (5). The fabric softener active in a liquid form and the second liquid composition pass through the orifice component (5) under pressure. The fabric softener active in liquid form and the second liquid composition can be at the same or different operating pressures. The orifice component (5) is configured, either alone, or in combination with some other component, to mix the liquid fabric softener active and the second liquid composition and/or produce shear and/or turbulence in each liquid, or the mixture of the liquids.

The liquids can be supplied to the apparatus A and B in any suitable manner including, but not limited to through the use of pumps and motors powering the same. The pumps can supply the liquids to the apparatus A under the desired operating pressure. In one embodiment, an ‘8 frame block-style manifold’ is used with a 781 type Plunger pump available from CAT pumps (1681 94th Lane NE, Minneapolis, Minn. 55449).

The operating pressure of conventional shear and/or turbulence apparatuses is typically between 2 bar and 490 bar. The operating pressure is the pressure of the liquid in the inlet 1A near inlet 1B. The operating pressure is provided by the pumps.

The operating pressure of Apparatus A is measured using a Cerphant T PTP35 pressure switch with a RVS membrane, manufactured by Endress Hauser (Endress+Hauser Instruments, International AG, Kaegenstrasse 2, CH-4153, Reinach). The switch is connected with the inlet 1A near inlet 1B using a conventional thread connection (male thread in the pre-mix chamber housing, female thread on the Cerphant T PTP35 pressure switch).

The operating pressure of Apparatus A may be lower than conventional shear and/or turbulence processes, yet the same degree of liquid mixing is achievable as seen with processes using conventional apparatuses. Also, at the same operating pressures, the process of the present invention results in better mixing than is seen with conventional shear and/orturbulence processes.

As the fabric softener active and the second liquid composition flow through the Apparatus A, they pass through the orifices (13) and (15) of the orifice component (5). As they do, they exit the orifice(s) (13) and/or (15) in the form of a jet. This jet produces shear and/or turbulence in the fabric softener active and the second liquid composition, thus dispersing them one in the other to form a uniform mixture.

In conventional shear and/or turbulence processes, the fact that the liquids are forced through the orifice(s) (13) and/or (15) under high pressure causes them to mix. This same degree of mixing is achievable at lower pressures when the liquids are forced through a series of orifices, rather than one at a high pressure. Also, at equivalent pressures, the process of the present invention results in better liquid mixing than shear and/or turbulence processes, due to the fact that the liquids are now forced through a series of orifices.

A given volume of liquid can have any suitable residence time and/or residence time distribution within the apparatus A. Some suitable residence times include, but are not limited to from 1 microsecond to 1 second, or more. The liquid(s) can flow at any suitable flow rate through the apparatus A. Suitable flow rates range from 1 to 1 500 L/min, or more, or any narrower range of flow rates falling within such range including, but not limited to from 5 to 1 000 L/min.

For Apparatus B Circulating Loop System example, one may find it convenient to characterize the circulation flow by a Circulation Loop Flow Rate Ratio which is equal to the Circulation Flow Rate divided by the Inlet Flow Rate. Said Circulation Loop Flow Rate Ratio for producing the desired fabric softener composition microstructure can be from 1 to 100, from 1 to 50, and even from 1 to 20. The fluid flow in the circulation loop imparts shear and turbulence to the liquid fabric softener to transform the liquid fabric softener intermediate into a desired dispersion microstructure.

The duration of time said liquid fabric softener intermediate spends in said Apparatus B may be quantified by a Residence Time equal to the total volume of said Circulation Loop System divided by said fabric softener intermediate inlet flow rate. Said Circulation Loop Residence Time for producing desirable liquid fabric softener composition microstructures may be from 0.1 seconds to 10 minutes, from 1 second to 1 minute, or from 2 seconds to 30 seconds. It is desirable to minimize the residence time distribution.

Shear and/or turbulence imparted to said liquid fabric softener intermediate may be quantified by estimating the total kinetic energy per unit fluid volume. The kinetic energy per unit volume imparted in the Circulation Loop System to the fabric softener intermediate in Apparatus B may be from 10 to 1 000 000 g·cm⁻¹·s⁻², from 50 to 500 000 g·cm⁻¹·s⁻², or from 100 to 100 000 g·cm⁻¹·s⁻². The liquid(s) flowing through Apparatus B can flow at any suitable flow rate. Suitable inlet and outlet flow rates range from 1 to 1 500 L/min, or more, or any narrower range of flow rates falling within such range including, but not limited to from 5 to 1 000 L/min. Suitable Circulation Flow Rates range from 1 L/min to 20 000 L/min or more, or any narrower range of flow rates falling within such range including but not limited to from 5 to 10 000 L/min. Apparatus A is ideally operated at the same time as Apparatus B to create a continuous process. The liquid fabric softener intermediate created in Apparatus A may also be stored in a suitable vessel and processed through apparatus B at a later time.

### EXAMPLES

First, concentrated Fabric softener premixes were made by adding 77 g of demineralized water (conductivity 3 μS/cm) and 22 g of an FSA premix containing FSA, isopropanol and coconut oil to a speedmixer (Speed Mixer DAC 150 FVZ, FlacTek Inc, Germany) container at 80° C. Adjunct ingredients such as NaHEDP chelant, formic acid, HCl, and preservative were added to the speedmixer container at 80° C. The speedmixer was operated at 3500 rpm for 1 minute. After termination, CaCl₂ was added using a 34% aqueous solution to the hot (above 45° C.) mixture in a 200 mL glass jar while mixing with a magnetic stirrer at 600 rpm for 3 minutes. The concentrated Fabric softener premix was left to cool to 20-21° C.

Thickener (cationic polymeric thickener or microfibrous cellulose) was added to the concentrated Fabric softener premix to obtain the concentrated fabric softener premix 1 and 2 using an IKA-mixer with a pitch-blade mixing for 5 minutes while gradually increasing the speed from 300 rpm to 900 rpm. Table 1 shows the composition of concentrated fabric softener premixes 1 and 2 having a similar viscosity.

TABLE 1
Concentrated fabric softener premix 1 and 2.

Weight %

| | Premix 1 | Premix 2 |
|---|---|---|
| Demineralized water | Balance | Balance |
| NaHEDP | 0.007 | 0.007 |
| Formic acid | 0.044 | 0.042 |
| Preservative^{a} | 0.022 | 0.021 |
| FSA^{b} | 19.0 | 18.0 |
| coconut oil | 0.65 | 0.61 |
| CaCl₂ | 0.20 | 0.19 |
| isopropanol | 1.94 | 1.84 |
| Cationic polymer emulsion^{c} | 1.75 | 0.00 |
| Microfibrous cellulose^{d} | 0.00 | 0.70 |
| Viscosity [mPa · s]^{e} | 1248 | 1280 |

^{a}Proxel GXL, 20% aqueous dipropylene glycol solution of 1,2-benzisothiazolin-3-one, supplied by Lonza.
^{b}N,N-bis(hydroxyethyl)-N,N-dimethyl ammonium chloride fatty acid ester. The iodine value of the parent fatty acid of this material is between 18 and 22. The material as obtained from Evonik contains impurities in the form of free fatty acid, the monoester form of N,N-bis(hydroxyethyl)-N,N-dimethyl ammonium chloride fatty acid ester, and fatty acid esters of N,N-bis(hydroxyethyl)-N-methylamine.
^{c}Flosoft FS222 ®, cross-linked cationic polymeric thickener supplied by SNF Floerger, expressed as weight % raw material.
^{d}Exilva ®, microfibrous cellulose, expressed as 100% dry matter, supplied as 10% aqueous dispersion by Borregaard
^{e}Brookfield ® DV-E viscosity at 60 rpm, spindle 3, measured at 21° C., 24 hours after making

Table 2 shows the compositions of the final fabric softener compositions obtained by diluting the concentrated FSA premixes 1 and 2 with demineralized water (conductivity 3 μS/cm) using a magnetic stirrer at 600 rpm for 3 minutes. Comparative Examples 1 and 3 were made by dilutions from premix 1. Examples 2 and 4 were obtained using a process according to the present invention and were obtained by diluting premix 2.

TABLE 2
Fabric softener composition examples 1 through 4. The examples
marked with an asterisk are comparative examples.

| | Weight % | | | |
|---|---|---|---|---|
| | Ex. 1* | Ex. 2 | Ex. 3* | Ex. 4 |
| Demineralized water | Balance | Balance | Balance | Balance |
| NaHEDP | 0.004 | 0.003 | 0.003 | 0.002 |
| Formic acid | 0.022 | 0.021 | 0.017 | 0.016 |
| Preservative | 0.011 | 0.010 | 0.008 | 0.008 |
| FSA | 9.6 | 9.0 | 7.2 | 6.7 |
| coconut oil | 0.33 | 0.31 | 0.25 | 0.23 |
| CaCl₂ | 0.10 | 0.09 | 0.07 | 0.07 |
| isopropanol | 0.98 | 0.92 | 0.74 | 0.69 |
| Cationic polymer emulsion^{c} | 0.88 | — | 0.66 | — |
| Microfibrous cellulose^{d} | — | 0.35 | — | 0.26 |
| FSA dilution ratio | 0.50 | 0.50 | 0.38 | 0.38 |
| % FSA final/% FSA premix | | | | |
| [—] | | | | |
| Viscosity [mPa · s]^{e} | 155 | 215 | 61 | 209 |
| Viscosity ratio | 0.12 | 0.17 | 0.05 | 0.16 |
| viscosity final/viscosity | | | | |
| premix [—] | | | | |

^{a} Proxel GXL, 20% aqueous dipropylene glycol solution of 1,2-benzisothiazolin-3-one, supplied by Lonza.
^{b} N,N-bis(hydroxyethyl)-N,N-dimethyl ammonium chloride fatty acid ester. The iodine value of the parent fatty acid of this material is between 18 and 22. The material as obtained from Evonik contains impurities in the form of free fatty acid, the monoester form of N,N-bis(hydroxyethyl)-N,N-dimethyl ammonium chloride fatty acid ester, and fatty acid esters of N,N-bis(hydroxyethyl)-N-methylamine.
^{c}Flosoft FS222 ®, cross-linked cationic polymeric thickener supplied by SNF Floerger, expressed as weight % raw material.
^{d}Exilva ®, microfibrous cellulose, expressed as 100% dry matter, supplied as 10% aqueous dispersion by Borregaard
^{e}Brookfield ® DV-E viscosity at 60 rpm, spindle 2, measured at 21° C., 24 hours after making

Upon dilution of the concentrated fabric softener premixes with demineralized water, the obtained fabric softener compositions (Example 1 through 4) had a lower viscosity than the concentrated premixes 1 and 2. In the case the concentrated fabric softener premixes comprised a cross-linked cationic polymeric thickener (Premix 1), the viscosity after dilution was less than 160 mPa·s and depended on the dilution level as illustrated by comparative Example 1 and 3. While a dilution to 9.6% FSA resulted in a viscosity of 155 mPa·s, the dilution to 7.2% FSA resulted in a further significant drop in viscosity of only 61 mPa·s, corresponding to a viscosity ratio of only 0.05. To provide compositions Ex. 1 and Ex. 3 with a similar and rich appearance additional thickener would have needed to be added which would result in increased manufacturing complexity and cost. Examples 2 and 4 demonstrate that when diluting a concentrated fabric softener premix comprising microfibrous cellulose, higher viscosities and hence compositions with a richer appearance were obtained than similar dilution steps in absence of microfibrous cellulose (Example 1 and 3). In addition, a similar viscosity for both dilution steps (Example 2 and 4) was obtained which further helps to avoid an additional manufacturing step to adjust the level of thickener to obtain the same rich appearance for both compositions.

Concentrated 11% fabric softener premixes were prepared according to the processes of making a concentrated fabric softener premix (see Methods). Thickener was added to the concentrated Fabric softener premix to obtain the concentrated fabric softener premix 3 and 4 with an FSA level of 10% using an IKA-mixer with a pitch-blade mixing for 5 minutes while gradually increasing the speed from 300 rpm to 900 rpm. Table 3 shows the composition of concentrated fabric softener premixes 3 and 4 having a similar viscosity.

TABLE 3
Concentrated fabric softener premix 3 and 4.

Weight %

| | Premix 3 | Premix 4 |
|---|---|---|
| Demineralized water | Balance | Balance |
| NaHEDP | 0.007 | 0.007 |
| Formic acid | 0.044 | 0.042 |
| HCl | 0.0088 | 0.0084 |
| Preservative^{a} | 0.022 | 0.021 |
| FSA^{b} | 10.4 | 9.9 |
| Antifoam | 0.099 | 0.094 |
| coconut oil | 0.35 | 0.34 |
| CaCl₂ | 0.015 | 0.014 |
| isopropanol | 1.1 | 1.0 |
| Encapsulated perfume | 0.2 | 0.2 |
| Perfume | 1.0 | 1.0 |
| Cationic polymer emulsion^{c} | 0.5 | — |
| Microfibrous cellulose^{d} | — | 0.5 |
| Viscosity [mPa · s]^{e} | 1398 | 1330 |

^{a}Proxel GXL, 20% aqueous dipropylene glycol solution of 1,2-benzisothiazolin-3-one, supplied by Lonza.
^{b}N,N-bis(hydroxyethyl)-N,N-dimethyl ammonium chloride fatty acid ester. The iodine value of the parent fatty acid of this material is between 18 and 22. The material as obtained from Evonik contains impurities in the form of free fatty acid, the monoester form of N,N-bis(hydroxyethyl)-N,N-dimethyl ammonium chloride fatty acid ester, and fatty acid esters of N,N-bis(hydroxyethyl)-N-methylamine.
^{c}Flosoft FS222 ®, cross-linked cationic polymeric thickener supplied by SNF Floerger, expressed as weight % raw material.
^{d}Exilva ®, microfibrous cellulose, expressed as 100% dry matter, supplied as 10% aqueous dispersion by Borregaard
^{e}Brookfield ® DV-E viscosity at 60 rpm, spindle 3, measured at 21° C., 24 hours after making

Table 4 shows the compositions of the final fabric softener compositions obtained by diluting the concentrated FSA premixes 3 and 4 with a 400 ppm CaCl₂ solution with a conductivity of 946 μS/cm, using a magnetic stirrer at 600 rpm for 3 minutes. Comparative Examples 5 and 7 were made by dilutions from premix 3. Examples 6 and 8 were obtained using a process according to the present invention and were obtained by diluting premix 4.

TABLE 4
Fabric softener composition examples 5 through 8. The examples
marked with an asterisk are comparative examples.

| | Weight % | | | |
|---|---|---|---|---|
| | Ex. 5* | Ex. 6 | Ex. 7* | Ex. 8 |
| Demineralized water | Balance | Balance | Balance | Balance |
| NaHEDP | 0.004 | 0.004 | 0.003 | 0.003 |
| Formic acid | 0.028 | 0.027 | 0.02 | 0.02 |
| HCl | 0.0056 | 0.0053 | 0.004 | 0.004 |
| Preservative^{a} | 0.014 | 0.013 | 0.01 | 0.01 |
| FSA^{b} | 6.6 | 6.3 | 4.7 | 4.5 |
| Antifoam | 0.06 | 0.06 | 0.05 | 0.04 |
| coconut oil | 0.23 | 0.21 | 0.16 | 0.15 |
| CaCl₂ | 0.02 | 0.02 | 0.03 | 0.03 |
| isopropanol | 0.68 | 0.64 | 0.48 | 0.46 |
| Encapsulated perfume | 0.13 | 0.13 | 0.09 | 0.09 |
| Perfume | 0.64 | 0.64 | 0.45 | 0.45 |
| Cationic polymer emulsion^{c} | 0.32 | — | 0.23 | — |
| Microfibrous cellulose^{d} | — | 0.35 | — | 0.25 |
| FSA dilution ratio | 0.64 | 0.64 | 0.45 | 0.45 |
| % FSA final/% FSA premix | | | | |
| [—] | | | | |
| Viscosity [mPa · s]^{e} | 205 | 301 | 41 | 131 |
| Viscosity ratio | 0.15 | 0.23 | 0.03 | 0.10 |
| viscosity final/viscosity | | | | |
| premix [—] | | | | |

^{a}Proxel GXL, 20% aqueous dipropylene glycol solution of 1,2-benzisothiazolin-3-one, supplied by Lonza.
^{b}N,N-bis(hydroxyethyl)-N,N-dimethyl ammonium chloride fatty acid ester. The iodine value of the parent fatty acid of this material is between 18 and 22. The material as obtained from Evonik contains impurities in the form of free fatty acid, the monoester form of N,N-bis(hydroxyethyl)-N,N-dimethyl ammonium chloride fatty acid ester, and fatty acid esters of N,N-bis(hydroxyethyl)-N-methylamine.
^{c}Flosoft FS222 ®, cross-linked cationic polymeric thickener supplied by SNF Floerger, expressed as weight % raw material.
^{d}Exilva ®, microfibrous cellulose, expressed as 100% dry matter, supplied as 10% aqueous dispersion by Borregaard
^{e}Brookfield ® DV-E viscosity at 60 rpm, spindle 2, measured at 21° C., 24 hours after making

At an FSA dilution ratio of 0.64, the composition thickened with cross-linked cationic polymer dropped from 1398 mPa·s to 205 mPa·s (ex. 5), yielding a viscosity ratio of only 0.15. On the contrary, the composition thickened with microfibrous cellulose maintained a higher viscosity ratio of 0.23 upon the same dilution step, resulting in a much richer appearance. While the absolute viscosity at a dilution ratio of 0.45 was lower for ex. 7 and 8, the viscosity of the cellulose thickened composition ex. 8 was more than 3 times than that of the composition thickened with a traditional cross-linked cationic polymer (ex. 7). As such, compositions thickened with cross-linked cationic polymer would have required additional polymer after the dilution step with a 400 ppm CaCl₂ solution to obtain the same rich appearance as the compositions thickened with microfibrous cellulose.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process to make a liquid fabric softener composition, comprising from about 3% to about 17% of a quaternary ammonium ester softening active and about 0.01% to about 5% of microfibrous cellulose, comprising the following steps:
a) manufacturing a concentrated fabric softener premix comprising from about 8% to about 35% of a quaternary ammonium ester softening active, and comprising microfibrous cellulose;
b) diluting the concentrated fabric softener premix with an aqueous dilution medium to form a liquid fabric softener composition comprising from about 3% to about 17% of a quaternary ammonium ester softening active;
wherein the liquid fabric softener composition comprises at most about 90% by weight of the composition of said concentrated fabric softener premix.

2. The process according to claim 1, wherein the liquid fabric softener comprises by weight of the composition at most about 80% of said concentrated fabric softener premix.

3. The process according to claim 1, wherein the concentrated fabric softener premix comprises by weight of the premix from about 8% to about 35% of quaternary ammonium ester softening active.

4. The process according to claim 1, wherein the liquid fabric softener composition comprises by weight of the composition from about 3% to about 15% of quaternary ammonium ester softening active.

5. The process according to claim 1, wherein the aqueous dilution medium comprises less than about 0.01% of thickener.

6. The process according to claim 1, wherein the aqueous dilution medium has a conductivity at about 20° C. less than about 7 mS/cm.

7. The process according to claim 1, wherein the quaternary ammonium ester softening active has the following formula:
{R²₍₄₋ₘ₎—N+—[X—Y—R¹]ₘ}A-
wherein:
m is 1, 2 or 3 with proviso that the value of each m is identical;
each R¹ is independently hydrocarbyl, or branched hydrocarbyl group, preferably R¹ is linear, more preferably R¹ is partially unsaturated linear alkyl chain;
each R² is independently a C₁-C₃ alkyl or hydroxyalkyl group, preferably R² is selected from methyl, ethyl, propyl, hydroxyethyl, 2-hydroxypropyl, 1-methyl-2-hydroxyethyl, poly(C₂₋₃ alkoxy), polyethoxy, benzyl;
each X is independently (CH₂)n, CH₂—CH(CH₃)— or CH—(CH₃)—CH₂— and
each n is independently 1, 2, 3 or 4, preferably each n is 2;
each Y is independently —O—(O)C— or —C(O)—O—;
A- is independently selected from the group consisting of chloride, methyl sulfate, and ethyl sulfate, preferably A- is selected from the group consisting of chloride and methyl sulfate;
with the proviso that the sum of carbons in each R¹, when Y is —O—(O)C—, is from about 13 to about 21.

8. The process according to claim 1, wherein the microfibrous cellulose is present in the liquid fabric softener composition at a level of from about 0.05% to about 1.0% by weight of the composition.

9. The process according to claim 1, wherein the microfibrous cellulose is derived from bacterial or botanical origin, preferably from botanical origin selected from the group consisting of citrus peel, fruit, vegetables, plants, wood, and mixtures thereof.

10. The process according to claim 1, wherein the microfibrous cellulose have an average diameter from about 10 nm to about 350 nm.

11. The process according to claim 1, wherein the viscosity of the liquid fabric softener composition is from about 50 mPa·s to about 1000 mPa·s, as measured at about 21° C. with a Brookfield® DV-E viscosity at about 60 rpm.

12. The process according to claim 1, wherein the liquid fabric softener composition further comprises a perfume, wherein the perfume is present at a level of from about 0.1% to about 5% by weight of the composition.

13. The process according to claim 11, wherein the perfume is added to the concentrated fabric softener premix in step a).

14. The process according to claim 1, wherein the liquid fabric softener composition further comprising from about 0.05% to about 8% by total weight of the composition of encapsulated benefit agent, said encapsulated benefit agent is encapsulated in capsules wherein said capsules comprise a capsule wall, said capsule wall comprising wall material selected from the group consisting of melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, resorcinol-based materials, poly-isocyanate-based materials, acetals (such as 1,3,5-triol-benzene-gluteraldehyde and 1,3,5-triol-benzene melamine), starch, cellulose acetate phthalate and mixtures thereof.

15. The process according to claim 1, wherein the concentrated fabric softener premix has a viscosity of about 50 mPa·s to about 10000 mPa·s, as measured at about 21° C. with a Brookfield® DV-E viscometer at about 60 rpm.
